(19) United States
(12) Patent Application Publication
(10) Pub. No.: US 2026/0116434 A1
(43) Pub. Date: Apr. 30, 2026

(54) Finished Vehicle Logistics Autonomy

(71) Applicant: Nissan North America, Inc., Franklin, TN (US)

(72) Inventors: Pratham Oza, San Jose, CA (US); Steven Bell, St. Augustine, FL (US); Josh Westerhold, Nashville, TN (US); Dhanesh Pamnani, Sunnyvale, CA (US)

(21) Appl. No.: 18/932,821

(22) Filed: Oct. 31, 2024

(51) Int. Cl. B60W 60/00

(52) U.S. Cl. CPC B60W 60/0025; B60W 2420/403; B60W 2556/45

(57) ABSTRACT

A finished vehicle logistics autonomy (FVLA) system located outside of a finished vehicle may generate driving instructions for controlling the finished vehicle to traverse a transportation network of a controlled roadway region. The FVLA system may transmit a control signal indicative of the driving instructions to an In-Vehicle Controller Unit (ICU). The ICU may include at least one sensor and be configured to receive the control signal from the FVLA system. The ICU may determine the driving instructions based on the control signal and control the finished vehicle to traverse the controlled roadway.

### TECHNICAL FIELD

The present disclosure relates to vehicle control systems, and more particularly to systems and methods for autonomously controlling finished vehicles within a controlled roadway region.

### BACKGROUND

In the automotive industry, finished vehicles, which are at least partially assembled and ready for sale or distribution, undergo several stages of handling after leaving the assembly line. These stages typically include quality control checks, temporary storage, and transportation to various distribution points. The movement of finished vehicles within a controlled environment, such as a manufacturing facility or distribution center, involves coordinating the transfer of vehicles between different areas such as testing facilities, storage lots, and loading zones for rail or truck transport.

### SUMMARY

A first aspect is a method for controlling a finished vehicle in a controlled roadway region. The method includes providing a finished vehicle logistics autonomy (FVLA) system located outside of the finished vehicle, the FVLA system configured to determine driving operations for controlling the finished vehicle; providing a removable In-Vehicle Controller Unit (ICU) for temporary installation in the finished vehicle, the ICU including at least one sensor; generating, using the FVLA system, driving instructions for controlling the finished vehicle to traverse a transportation network of the controlled roadway region; and transmitting a control signal to the ICU, the control signal indicative of the driving instructions.

A second aspect is a system for controlling a finished vehicle in a controlled roadway region. The system includes an FVLA system located outside of the finished vehicle. The FVLA system is configured to generate driving instructions for controlling the finished vehicle to traverse a transportation network of the controlled roadway region; and transmit a control signal indicative of the driving instructions to an ICU. The ICU includes at least one sensor and is configured to receive the control signal from the FVLA system; determine the driving instructions based on the control signal; and control the finished vehicle to traverse the controlled roadway.

A third aspect is an apparatus for facilitating control of a finished vehicle in a controlled roadway region. The apparatus includes a processor of an ICU configured to cause the ICU to receive a control signal indicative of driving instructions from an FVLA system located outside of the finished vehicle and control the finished vehicle to traverse a transportation network of the controlled roadway region.

Variations in these and other aspects, features, elements, implementations, and embodiments of the methods, apparatus, procedures, and algorithms disclosed herein are described in further detail hereafter.

### BRIEF DESCRIPTION OF THE DRAWINGS

The various aspects disclosed herein will become more apparent by referring to the examples provided in the following description and drawings in which like reference numbers refer to like elements.

FIG. 1 is a diagram of an example of a vehicle in which the aspects, features, and elements disclosed herein may be implemented.

FIG. 2 is a diagram of an example of a portion of a vehicle transportation and communication system in which the aspects, features, and elements disclosed herein may be implemented.

FIG. 3 shows a block diagram of an example of a computing device 300 capable of performing functions described later herein.

FIG. 4 illustrates an example of a controlled roadway region 400, in accordance with the present disclosure.

FIG. 5 is a data flow diagram of a long-term shared world model architecture in accordance with embodiments of this disclosure.

FIG. 5 is a flow diagram illustrating an example of a process 500 for controlling a finished vehicle in a controlled roadway region, in accordance with the present disclosure.

FIG. 6 is a schematic diagram showing an operating environment 600 within which aspects of the system and apparatuses described herein may be implemented.

FIG. 7 is a diagram of an example of a vehicle 700 having an ICU 702 temporarily installed therein, in accordance with the present disclosure.

FIG. 8 is a diagram illustrating an example 800 associated with controlling a finished vehicle in a controlled roadway region, in accordance with the present disclosure.

FIG. 9 is a diagram illustrating another example 900 associated with controlling a finished vehicle in a controlled roadway region, in accordance with the present disclosure.

FIG. 10 is a schematic diagram illustrating an example 1000 associated with using a tele-operation device to control a finished vehicle in a controlled roadway region, in accordance with the present disclosure.

### DETAILED DESCRIPTION

In the automotive industry, the logistics of managing finished vehicles from the assembly line to distribution points presents challenges. These challenges are particularly acute in the final stages of production, where vehicles must be moved through various checkpoints, testing areas, and storage facilities before reaching their final distribution channels. Traditional methods of managing this process often rely heavily on human drivers, which can lead to inefficiencies, increased costs, and potential safety risks within the controlled environment of a manufacturing facility.

The complexity of coordinating multiple vehicles simultaneously, each at different stages of the post-production process, poses a challenge. Human operators must navigate intricate facility layouts, adhere to strict safety protocols, and ensure timely movement of vehicles, all while minimizing the risk of damage to newly manufactured assets. This manual approach is not only labor-intensive but also prone to human error, potentially resulting in delays, accidents, or misrouting of vehicles.

Furthermore, the increasing demand for customization and just-in-time delivery in the automotive sector has amplified the need for a more flexible and responsive logistics system. Some of the challenges lie in developing a solution that can autonomously manage the movement of finished vehicles with precision and efficiency, while also being adaptable to changes in production schedules, facility layouts, and distribution requirements. Such a system would benefit from being capable of real-time decision-making, seamless integration with existing manufacturing processes, and the ability to handle exceptions without compromising the overall flow of operations.

Implementations of this disclosure address problems such as these by providing a finished vehicle logistics autonomy (FVLA) system located outside of a finished vehicle and configured to determine driving operations for controlling the finished vehicle. The FVLA system may generate driving instructions for controlling the finished vehicle to traverse a transportation network of a controlled roadway region. A removable In-Vehicle Controller Unit (ICU) may be temporarily installed in the finished vehicle, with the ICU including at least one sensor. The FVLA system may transmit a control signal to the ICU, where the control signal is indicative of the driving instructions.

As used herein, the term “finished vehicle” may refer to an at least partially assembled vehicle that has completed a manufacturing process and is ready for distribution, sale, or transportation to another location (e.g., for testing, validation, further manufacturing, troubleshooting, etc.). The term “controlled roadway region” may include a defined area within which a majority of the traffic on the roadways therein is subject to control by a single entity (e.g., a human operator, a company, a conglomerate of companies, a governmental entity, etc.). One example of a controlled roadway region is an area in which finished vehicles are managed and transported, such as a factory property, test course, or distribution center, among other examples. The term “In-Vehicle Controller Unit” or “ICU” may refer to a removable device that can be temporarily installed in a finished vehicle to enable autonomous or remote-controlled operation of the vehicle within the controlled roadway region.

A controlled roadway region, as defined in this disclosure, differs significantly from a typical roadway region in a number of aspects. In a controlled roadway region, a single entity has authority over the majority of traffic, allowing for a more structured and predictable environment. This level of control enables the implementation of specialized systems and protocols that may not be feasible in typical roadway regions where traffic is more diverse and less regulated.

One of the primary differences is the ability to implement comprehensive sensor networks and infrastructure components throughout the controlled roadway region. These systems may include cameras, light detection and ranging (LIDAR) sensors, and other monitoring devices that provide real-time data about vehicle positions, speeds, and/or environmental conditions. In contrast, typical roadway regions may have limited sensor coverage, relying more heavily on individual vehicle sensors and sporadic traffic monitoring systems.

The controlled nature of the roadway region also allows for the implementation of standardized communication protocols between vehicles and infrastructure. This may include dedicated short-range communication (DSRC) systems or cellular vehicle-to-everything (C-V2X) technologies that enable seamless information exchange. Such comprehensive communication networks are often not feasible in typical roadway regions due to the diverse range of vehicles and the challenges of retrofitting existing infrastructure.

Implementations of the FVLA system described herein take advantage of these differences by utilizing the controlled environment to create a more efficient and predictable system for managing finished vehicles. The FVLA system can leverage the comprehensive sensor data and communication networks to maintain an accurate and up-to-date world model of the entire controlled roadway region. This allows for more precise planning and coordination of vehicle movements, reducing the likelihood of conflicts or inefficiencies that might occur in less controlled environments.

Furthermore, the short, established routes that finished vehicles need to take within the controlled roadway region present unique opportunities for optimization. Unlike typical automated vehicles that may need to navigate complex and unpredictable city streets or highways, finished vehicles in a controlled roadway region follow predetermined paths between known points of interest, such as assembly lines, testing areas, and distribution centers. This allows the FVLA system to create highly optimized trajectories and schedules, taking into account factors such as production timing, vehicle specifications, and distribution requirements.

The controlled environment also enables the use of simplified ICUs in finished vehicles. These ICUs can be designed specifically for the controlled roadway region, focusing on the limited set of maneuvers and routes required within the facility. This contrasts with the more complex autonomous driving systems needed for typical automated vehicles that must handle a wide range of driving scenarios and environments. The simplified ICUs may be more cost-effective and easier to install and remove, facilitating the efficient movement of finished vehicles through the logistics process.

According to some implementations, an FVLA system (which may be implemented as one or more physical machines and/or virtual machines) accesses infrastructure data from sensors of an infrastructure associated with a roadway portion of the controlled roadway region. The sensors may include any number of different types of roadway sensors. The infrastructure data may include a position of a vehicle, a velocity of a vehicle, and/or a following distance of another vehicle in relation to the vehicle, among other examples. The FVLA system may store the infrastructure data in a world model. The FVLA system may generate, using the world model, a data structure representing predicted future velocities on the roadway portion by position and time by applying a traffic flow model to the world model. The traffic flow model may be, for example, an artificial intelligence model trained using at least one of supervised learning, unsupervised learning, reinforcement learning, online learning, or the like.

The FVLA system transmits a control signal to the removable ICU provided in a finished vehicle for controlling operation of the finished vehicle based on the generated data structure. In some implementations, the ICU may be connected to a controller of the finished vehicle. The controller may include a computing device on board the finished vehicle. More generally, the control signal can be transmitted with respect to any vehicle that includes an ICU.

In an example, the control signal can be a specific control parameter (e.g., specific control parameter values) that may be used to control a component of the powertrain of the finished vehicle. In another example, the control signal can be or include data that the ICU can use to obtain the control parameter. For example, the ICU may be or include a machine leaning model that uses at least portions of the control signal to obtain (e.g., infer, output) the control parameter that can be used to control the component of the powertrain of the finished vehicle. The control parameter can depend on the capabilities of the ICU and/or of the vehicle.

Implementations of this disclosure may enable the ICU to receive additional instructions from a tele-operation device to control the finished vehicle. This capability allows for human intervention when necessary, providing a flexible system that can adapt to unexpected situations or complex scenarios that may arise during the logistics process. The system may also determine an occurrence of an operation issue with the finished vehicle and communicate an indication of the operation issue to the tele-operation device, facilitating rapid response to potential problems and maintaining efficient operations within the controlled roadway region.

As used herein, the term “model” may include, among other things, at least one of a classic planning model, an artificial intelligence (AI) model, or a machine-learning (ML) model that uses supervised learning, unsupervised learning, reinforcement learning, or the like. A model may be based on data that was generated in the past and may be used to predict future data. For example, a long-term shared world model of a roadway portion may store data about average velocities and congestion (e.g., number of vehicles per unit distance) of the roadway portion in the past (e.g., at multiple times in the past three years) and be used to predict the average velocities and the congestion of the roadway portion in the future (e.g., next Monday morning at 9 am). The prediction may be made, for example, using AI or ML techniques or other mathematical modeling techniques.

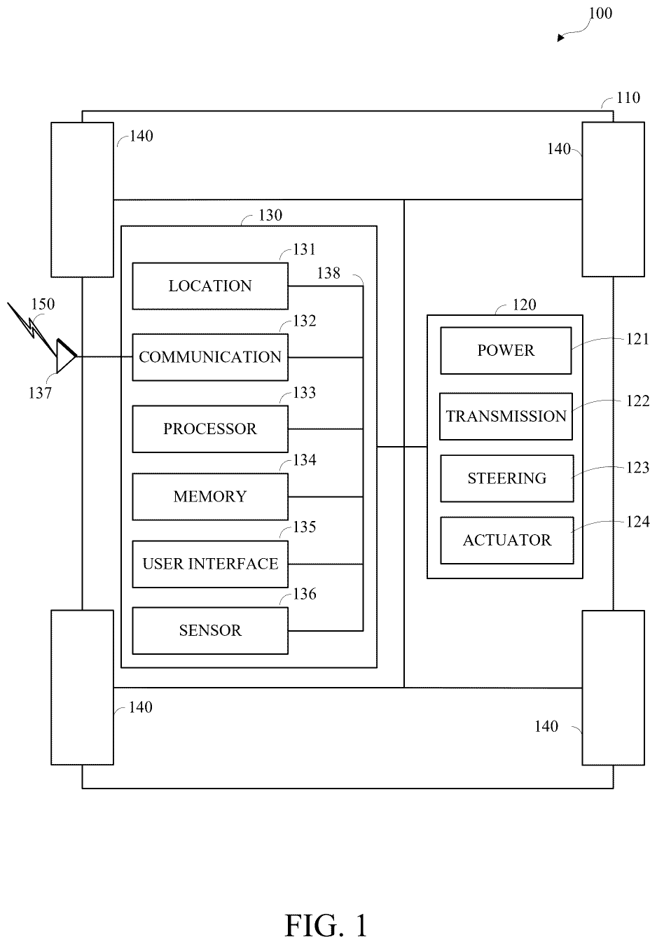

FIG. 1 is a diagram of an example of a vehicle in which the aspects, features, and elements disclosed herein may be implemented. As shown, a vehicle 100 includes a chassis 110, a powertrain 120, a controller 130, and wheels 140. Although the vehicle 100 is shown as including four wheels 140 for simplicity, any other propulsion device or devices, such as a propeller or tread, may be used. In FIG. 1, the lines interconnecting elements, such as the powertrain 120, the controller 130, and the wheels 140, indicate that information, such as data or control signals, power, such as electrical power or torque, or both information and power, may be communicated between the respective elements. For example, the controller 130 may receive power from the powertrain 120 and may communicate with the powertrain 120, the wheels 140, or both, to control the vehicle 100, which may include accelerating, decelerating, steering, or otherwise controlling the vehicle 100.

As shown, the powertrain 120 includes a power source 121, a transmission 122, a steering unit 123, and an actuator 124. Other elements or combinations of elements of a powertrain, such as a suspension, a drive shaft, axles, or an exhaust system may be included. Although shown separately, the wheels 140 may be included in the powertrain 120.

The power source 121 may include an engine, a battery, or a combination thereof. The power source 121 may be any device or combination of devices operative to provide energy, such as electrical energy, thermal energy, or kinetic energy. For example, the power source 121 may include an engine, such as an internal combustion engine, an electric motor, or a combination of an internal combustion engine and an electric motor, and may be operative to provide kinetic energy as a motive force to one or more of the wheels 140. The power source 121 may include a potential energy unit, such as one or more dry cell batteries, such as nickel-cadmium (NiCd), nickel-zinc (NiZn), nickel metal hydride (NiMH), lithium-ion (Li-ion); solar cells; fuel cells; or any other device capable of providing energy.

The transmission 122 may receive energy, such as kinetic energy, from the power source 121, and may transmit the energy to the wheels 140 to provide a motive force. The transmission 122 may be controlled by the controller 130 the actuator 124 or both. The steering unit 123 may be controlled by the controller 130 the actuator 124 or both and may control the wheels 140 to steer the vehicle. The actuator 124 may receive signals from the controller 130 and may actuate or control the power source 121, the transmission 122, the steering unit 123, or any combination thereof to operate the vehicle 100.

As shown, the controller 130 may include a location unit 131, an electronic communication unit 132, a processor 133, a memory 134, a user interface 135, a sensor 136, an electronic communication interface 137, or any combination thereof. Although shown as a single unit, any one or more elements of the controller 130 may be integrated into any number of separate physical units. For example, the user interface 135 and the processor 133 may be integrated in a first physical unit and the memory 134 may be integrated in a second physical unit. Although not shown in FIG. 1, the controller 130 may include a power source, such as a battery. Although shown as separate elements, the location unit 131, the electronic communication unit 132, the processor 133, the memory 134, the user interface 135, the sensor 136, the electronic communication interface 137, or any combination thereof may be integrated in one or more electronic units, circuits, or chips.

The processor 133 may include any device or combination of devices capable of manipulating or processing a signal or other information now-existing or hereafter developed, including optical processors, quantum processors, molecular processors, or a combination thereof. For example, the processor 133 may include one or more special purpose processors, one or more digital signal processors, one or more microprocessors, one or more controllers, one or more microcontrollers, one or more integrated circuits, one or more Application Specific Integrated Circuits, one or more Field Programmable Gate Array, one or more programmable logic arrays, one or more programmable logic controllers, one or more state machines, or any combination thereof. The processor 133 may be operatively coupled with the location unit 131, the memory 134, the electronic communication interface 137, the electronic communication unit 132, the user interface 135, the sensor 136, the powertrain 120, or any combination thereof. For example, the processor may be operatively coupled with the memory 134 via a communication bus 138.

The memory 134 may include any tangible non-transitory computer-usable or computer-readable medium, capable of, for example, containing, storing, communicating, or transporting machine readable instructions, or any information associated therewith, for use by or in connection with the processor 133. The memory 134 may be, for example, one or more solid state drives, one or more memory cards, one or more removable media, one or more read-only memories, one or more random access memories, one or more disks, including a hard disk, a floppy disk, an optical disk, a magnetic or optical card, or any type of non-transitory media suitable for storing electronic information, or any combination thereof.

The communication interface 137 may be a wireless antenna, as shown, a wired communication port, an optical communication port, or any other wired or wireless unit capable of interfacing with a wired or wireless electronic communication medium 150. Although FIG. 1 shows the communication interface 137 communicating via a single communication link, a communication interface may be configured to communicate via multiple communication links. The communication interface 137 may be in communication with a satellite. Although FIG. 1 shows a single communication interface 137, a vehicle may include any number of communication interfaces.

The communication unit 132 may be configured to transmit and/or receive signals via a wired or wireless electronic communication medium 150, such as via the communication interface 137. Although not explicitly shown in FIG. 1, the communication unit 132 may be configured to transmit, receive, or both via any wired or wireless communication medium, such as radio frequency (RF), ultraviolet (UV), visible light, fiber optic, wireline, satellite signals, or a combination thereof. For example, the communication unit 132 may be configured to transmit and/or receive telecommunication protocols such as 4G, 5G, Long Term Evolution (LTE), and/or 6G, among other examples. The communication unit 132 may be configured to communicate via sidelink networks using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols, among other examples. Although FIG. 1 shows a single communication unit 132 and a single communication interface 137, any number of communication units and any number of communication interfaces may be used. The communication unit 132 may include a dedicated short-range communications (DSRC) unit, an on-board unit (OBU), or a combination thereof.

The location unit 131 may determine geolocation information, such as longitude, latitude, elevation, direction of travel, or velocity, of the vehicle 100. For example, the location unit may include or be in communication with, a global positioning system (GPS) unit, a global navigation satellite system (GNSS), a Wide Area Augmentation System (WAAS) enabled National Marine-Electronics Association (NMEA) unit, a radio triangulation unit, or a combination thereof. The location unit 131 can be used to obtain information that represents, for example, a current heading of the vehicle 100, a current position of the vehicle 100 in two or three dimensions, a current angular orientation of the vehicle 100, or a combination thereof.

The user interface 135 may include any unit capable of interfacing with a person, such as a virtual or physical keypad, a touchpad, a display, a touch display, a heads-up display, a virtual display, an augmented reality display, a haptic display, a feature tracking device, such as an eye-tracking device, a speaker, a microphone, a video camera, a sensor, a printer, or any combination thereof. The user interface 135 may be operatively coupled with the processor 133, as shown, or with any other element of the controller 130. Although shown as a single unit, the user interface 135 may include one or more physical units. For example, the user interface 135 may include an audio interface for performing audio communication with a person and a touch display for performing visual and touch-based communication with the person. The user interface 135 may include multiple displays, such as multiple physically separate units, multiple defined portions within a single physical unit, or a combination thereof.

The sensor 136 may include one or more sensors, such as an array of sensors, which may be operable to provide information that may be used to control the vehicle. The sensors 136 may provide information regarding current operating characteristics of the vehicle 100. The sensor 136 can include, for example, a speed sensor, acceleration sensors, a steering angle sensor, traction-related sensors, braking-related sensors, steering wheel position sensors, eye tracking sensors, seating position sensors, lidar, GPS. GNSS, internal measurement unit (IMU), cameras, or any sensor, or combination of sensors, operable to report information regarding some aspect of the current dynamic situation of the vehicle 100.

The sensor 136 may include one or more sensors operable to obtain information regarding the physical environment surrounding the vehicle 100. For example, one or more sensors may detect road geometry and features, such as lane lines, and obstacles, such as fixed obstacles, vehicles, and pedestrians. The sensor 136 can be or include one or more video cameras, laser-sensing systems, infrared-sensing systems, acoustic-sensing systems, or any other suitable type of on-vehicle environmental sensing device, or combination of devices, now known or later developed. In some embodiments, the sensors 136 and the location unit 131 may be a combined unit.

Although not shown separately, the vehicle 100 may include a trajectory follower. For example, the controller 130 may include the trajectory follower. The trajectory controller may be operable to obtain information describing a current state of the vehicle 100 and a route planned for the vehicle 100, and, based on this information, to determine and optimize a trajectory for the vehicle 100. In some embodiments, the trajectory follower may output signals operable to control the vehicle 100 such that the vehicle 100 follows the trajectory that is determined by the trajectory follower. In some embodiments, the trajectory follower may follow a trajectory that is determined by an external system (e.g., an FVLA system). A trajectory may include an optimized trajectory that may be supplied to the powertrain 120, the wheels 140, or both. In some embodiments, the optimized trajectory can be control inputs such as a set of steering angles, with each steering angle corresponding to a point in time or a position. In some embodiments, the optimized trajectory can be one or more paths, lines, curves, or a combination thereof.

One or more of the wheels 140 may be a steered wheel, which may be pivoted to a steering angle under control of the steering unit 123, a propelled wheel, which may be torqued to propel the vehicle 100 under control of the transmission 122, or a steered and propelled wheel that may steer and propel the vehicle 100.

A vehicle may include units, or elements, not expressly shown in FIG. 1, such as an enclosure, a Bluetooth® module, a frequency modulated (FM) radio unit, a Near Field Communication (NFC) module, a liquid crystal display (LCD) display unit, an organic light-emitting diode (OLED) display unit, a speaker, or any combination thereof.

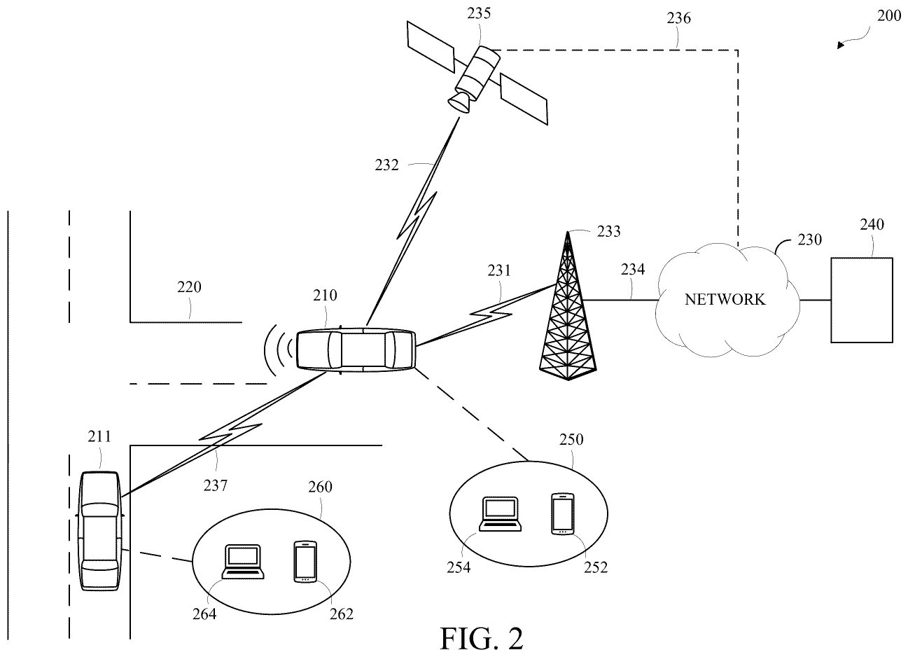

FIG. 2 is a diagram of an example of a portion of a vehicle transportation and communication system 200 in which the aspects, features, and elements disclosed herein may be implemented. The vehicle transportation and communication system 200 may include one or more vehicles 210/211, such as the vehicle 100 shown in FIG. 1, which may travel via one or more portions of one or more vehicle transportation networks 220, and may communicate via one or more electronic communication networks 230. Although not explicitly shown in FIG. 2, a vehicle may traverse an area that is not expressly or completely included in a vehicle transportation network, such as an off-road area.

The electronic communication network 230 may be, for example, a multiple access system and may provide for communication, such as voice communication, data communication, video communication, messaging communication, or a combination thereof, between the vehicle 210/211 and one or more communication devices 240. For example, a vehicle 210/211 may receive information, such as information representing the vehicle transportation network 220, from a communication device 240 via the network 230.

In some embodiments, a vehicle 210/211 may communicate via a wired communication link (not shown), a wireless communication link 231/232/237, or a combination of any number of wired or wireless communication links. For example, as shown, a vehicle 210/211 may communicate via a terrestrial wireless communication link 231, via a non-terrestrial wireless communication link 232, or via a combination thereof. The terrestrial wireless communication link 231 may include an Ethernet link, a serial link, a Bluetooth link, an infrared (IR) link, a UV link, an RF link, or any link capable of providing for electronic communication.

A vehicle 210/211 may communicate with another vehicle 210/2110. For example, a host, or subject, vehicle (HV) 210 may receive one or more automated inter-vehicle messages, such as a basic safety message (BSM), from a remote, or target, vehicle (RV) 211, via a direct communication link 237, or via a network 230. For example, the remote vehicle 211 may broadcast the message to host vehicles within a defined broadcast range, such as 300 meters. In some embodiments, the host vehicle 210 may receive a message via a third party, such as a signal repeater (not shown) or another remote vehicle (not shown). A vehicle 210/211 may transmit one or more automated inter-vehicle messages periodically, based on, for example, a defined interval, such as 100 milliseconds.

Automated inter-vehicle messages may include vehicle identification information, geospatial state information, such as longitude, latitude, or elevation information, geospatial location accuracy information, kinematic state information, such as vehicle acceleration information, yaw rate information, velocity information, vehicle heading information, braking system status information, throttle information, steering wheel angle information, or vehicle routing information, or vehicle operating state information, such as vehicle size information, headlight state information, turn signal information, wiper status information, transmission information, or any other information, or combination of information, relevant to the transmitting vehicle state. For example, transmission state information may indicate whether the transmission of the transmitting vehicle is in a neutral state, a parked state, a forward state, or a reverse state.

The vehicle 210 may communicate with the communications network 230 via an access point 233. The access point 233, which may include a computing device, may be configured to communicate with a vehicle 210, with a communication network 230, with one or more communication devices 240, or with a combination thereof via wired or wireless communication links 231/234. For example, the access point 233 may be a base station, a base transceiver station (BTS), a Node-B, an enhanced Node-B (eNode-B), a Home Node-B (HNode-B), a central unit (CU), a distributed unit (DU), a radio unit (RU), an NR network node, a 6G network node, a transmission reception point (TRP), a mobility element of a network, a core network node, a network element, a network equipment, a wireless router, a wired router, a hub, a relay, a switch, or any similar wired or wireless device. Although shown as a single unit in FIG. 2, an access point may include any number of interconnected elements. An access point may be stationary or mobile.

The vehicle 210 may communicate with the communications network 230 via a satellite 235 or other non-terrestrial communication device. The satellite 235, which may include a computing device, may be configured to communicate with a vehicle 210, with a communication network 230, with one or more communication devices 240, or with a combination thereof via one or more communication links 232/236. Although shown as a single unit in FIG. 2, a satellite may include any number of interconnected elements.

An electronic communication network 230 may be any type of network configured to provide voice, data, or any other type of electronic communication. For example, the electronic communication network 230 may include a local area network (LAN), a wide area network (WAN), a virtual private network (VPN), a mobile or cellular telephone network, the Internet, an Internet of Things (IoT) network, or any other electronic communication system. The electronic communication network 230 may use a communication protocol, such as transmission control protocol (TCP), user datagram protocol (UDP), internet protocol (IP), real-time transport protocol (RTP), HyperText Transport Protocol (HTTP), or a combination thereof. Although shown as a single unit in FIG. 2, an electronic communication network may include any number of interconnected elements.

The vehicle 210 may identify a portion or condition of the vehicle transportation network 220. For example, the vehicle 210 may include one or more on-vehicle sensors, such as sensor 136 shown in FIG. 1, which may include a velocity sensor, a wheel velocity sensor, a camera, a gyroscope, an optical sensor, a laser sensor, a radar sensor, a sonic sensor, or any other sensor or device or combination thereof capable of determining or identifying a portion or condition of the vehicle transportation network 220. The sensor data may include lane line data, remote vehicle location data, or both.

The vehicle 210 may traverse a portion or portions of one or more vehicle transportation networks 220 using information communicated via the network 230, such as information representing the vehicle transportation network 220, information identified by one or more on-vehicle sensors, or a combination thereof.

Although for simplicity FIG. 2 shows two vehicles 210, 211, one vehicle transportation network 220, one electronic communication network 230, and one communication device 240, any number of vehicles, networks, and/or computing devices may be used. The vehicle transportation and communication system 200 may include devices, units, or elements not shown in FIG. 2. Although the vehicle 210 is shown as a single unit, a vehicle may include any number of interconnected elements.

Although the vehicle 210 is shown communicating with the communication device 240 via the network 230, the vehicle 210 may communicate with the communication device 240 via any number of direct or indirect communication links. For example, the vehicle 210 may communicate with the communication device 240 via a direct communication link, such as a Bluetooth communication link.

In some embodiments, a vehicle 210/211 may be associated with an entity 250/260, such as a driver, operator, or owner of the vehicle. In some embodiments, an entity 250/260 associated with a vehicle 210/211 may be associated with one or more personal electronic devices 252/254/262/264, such as a smartphone 252/262 or a computer 254/264. In some embodiments, a personal electronic device 252/254/262/264 may communicate with a corresponding vehicle 210/211 via a direct or indirect communication link. Although one entity 250/260 is shown as associated with a respective vehicle 210/211 in FIG. 2, any number of vehicles may be associated with an entity and any number of entities may be associated with a vehicle.

The vehicle transportation network 220 shows only navigable areas (e.g., roads), but the vehicle transportation network may also include one or more unnavigable areas, such as a building, one or more partially navigable areas, such as a parking area or pedestrian walkway, or a combination thereof. The vehicle transportation network 220 may also include one or more interchanges between one or more navigable, or partially navigable, areas. A portion of the vehicle transportation network 220, such as a road, may include one or more lanes and may be associated with one or more directions of travel.

A vehicle transportation network 220, or a portion thereof, may be represented as vehicle transportation network data. For example, vehicle transportation network data may be expressed as a hierarchy of elements, such as markup language elements, which may be stored in a database or file. For simplicity, the figures herein depict vehicle transportation network data representing portions of a vehicle transportation network 220 as diagrams or maps; however, vehicle transportation network data may be expressed in any computer-usable form capable of representing a vehicle transportation network, or a portion thereof. The vehicle transportation network data may include vehicle transportation network control information, such as direction of travel information, speed limit information, toll information, grade information, such as inclination or angle information, surface material information, aesthetic information, defined hazard information, or a combination thereof.

A portion, or a combination of portions, of the vehicle transportation network 220 may be identified as a point of interest or a destination. For example, the vehicle transportation network data may identify a building as a point of interest or destination. The point of interest or destination may be identified using a discrete uniquely identifiable geolocation. For example, the vehicle transportation network 220 may include a defined location, such as a street address, a postal address, a vehicle transportation network address, a GPS address, or a combination thereof for the destination.

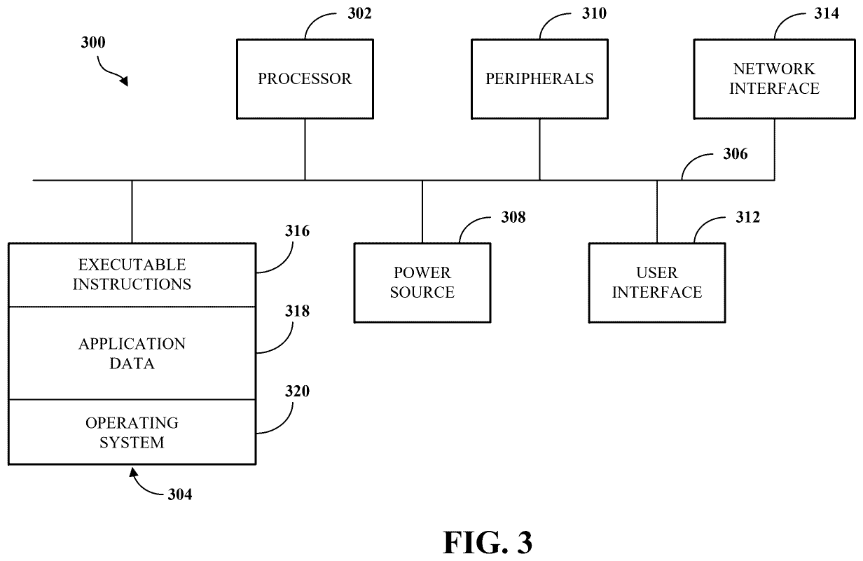

FIG. 3 shows a block diagram of an example of a computing device 300 capable of performing functions described herein. The computing device 300 may be, be similar to, include, or be included in, an apparatus for performing one or more methods, processes, algorithms, operations, tasks, and/or techniques, as described herein. The computing device 300 may be, be similar to, include, or be included in, an ICU, an FVLA system, a fleet management device, a tele-operation device, a sensor, a communication device, a vehicle controller (e.g., the controller 130 shown in FIG. 1) and/or a vehicle computer, among other examples. The computing device 300 includes components or units, such as a processor 302, a memory 304, a bus 306, a power source 308, peripherals 310, a user interface 312, a network interface 314, other suitable components, or a combination thereof. One or more of the memory 304, the power source 308, the peripherals 310, the user interface 312, or the network interface 314 can communicate with the processor 302 via the bus 306.

The processor 302 may be a central processing unit, such as a microprocessor, and may include single or multiple processors having single or multiple processing cores. The processor 302 can include another type of device, or multiple devices, configured for manipulating or processing information. For example, the processor 302 can include multiple processors interconnected in one or more manners, including hardwired or networked. The operations of the processor 302 can be distributed across multiple devices or units that can be coupled directly or across a local area or other suitable type of network. The processor 302 can include a cache, or cache memory, for local storage of operating data or instructions.

The memory 304 includes one or more memory components, which may each be volatile memory or non-volatile memory. For example, the volatile memory can be random access memory (RAM) (e.g., a DRAM module, such as DDR SDRAM). In another example, the non-volatile memory of the memory 304 can be a disk drive, a solid state drive, flash memory, or phase-change memory. In some implementations, the memory 304 can be distributed across multiple devices. For example, the memory 304 can include network-based memory or memory in multiple clients or servers performing the operations of those multiple devices.

The memory 304 can include data for immediate access by the processor 302. For example, the memory 304 can include executable instructions 316, application data 318, and an operating system 320. The executable instructions 316 can include one or more application programs, which can be loaded or copied, in whole or in part, from non-volatile memory to volatile memory to be executed by the processor 302. For example, the executable instructions 316 can include instructions for performing techniques of this disclosure. In some implementations, the application data 318 can include functional programs, such as a computational programs, analytical programs, database programs, and so on. The operating system 320 can be, for example, Microsoft Windows®, Mac OS X®, or Linux®; an operating system for a mobile device, such as a smartphone or tablet device; or an operating system for a non-mobile device, such as a mainframe computer.

The power source 308 provides power to the computing device 300. For example, the power source 308 can be an interface to an external power distribution system. In another example, the power source 308 can be a battery, such as where the computing device 300 is a mobile device or is otherwise configured to operate independently of an external power distribution system. In some implementations, the computing device 300 may include or otherwise use multiple power sources. In some such implementations, the power source 308 can be a backup battery.

The peripherals 310 may include one or more sensors, detectors, or other devices configured for monitoring the computing device 300 or the environment around the computing device 300. For example, the peripherals 310 can include a geolocation component, such as a GPS location unit. In another example, the peripherals can include a temperature sensor for measuring temperatures of components of the computing device 300, such as the processor 302. In some implementations, the computing device 300 can omit the peripherals 310.

The user interface 312 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 314 provides a connection or link to a network (e.g., the electronic communication network 230 shown in FIG. 2). The network interface 314 can be a wired network interface or a wireless network interface. The computing device 300 can communicate with other devices via the network interface 314 using one or more network protocols, such as using Ethernet, TCP, IP, power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof. For example, the computing device 300 can communicate with a database server.

The network interface 314 may include a transceiver, which may include a transmitter or a receiver. In some configurations, one or a combination of antenna(s), modem(s), multiple input multiple output (MIMO) detectors, receive processors, transmit processors, and/or the transmit MIMO processors may be included in the transceiver. The transceiver may be under control of or used by one or more processors, and in some aspects in conjunction with processor-readable code stored in the memory, to perform aspects of the methods, processes, techniques, and/or operations described herein.

In the description herein, sentences describing a vehicle, a system, or a device as taking an action (such as performing, determining, initiating, receiving, calculating, deciding, etc.) are to be understood that some appropriate component of the vehicle, system, or device as taking the action. Such components may refer to hardware and/or software configured to take the action.

An apparatus, computing device (e.g., the computing device 300), system, and/or vehicle, described herein may include one or more chips, system-on-chips (SoCs), chipsets, packages, and/or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include a memory system in the form of one or more memory devices, memory blocks, memory elements or other discrete gate or transistor logic or circuitry, each of which may include tangible storage media such as RAM or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The apparatus may include or may be included in a housing that houses components associated with the apparatus including the processing system.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 3, such as a single processor or a combination of multiple different processors. Reference to “one or more processors” should be understood to refer to any one or more of the processors described in connection with FIG. 3.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 3. For example, operation described as being performed by one or more memories can be performed by the same subset of the one or more memories or different subsets of the one or more memories.

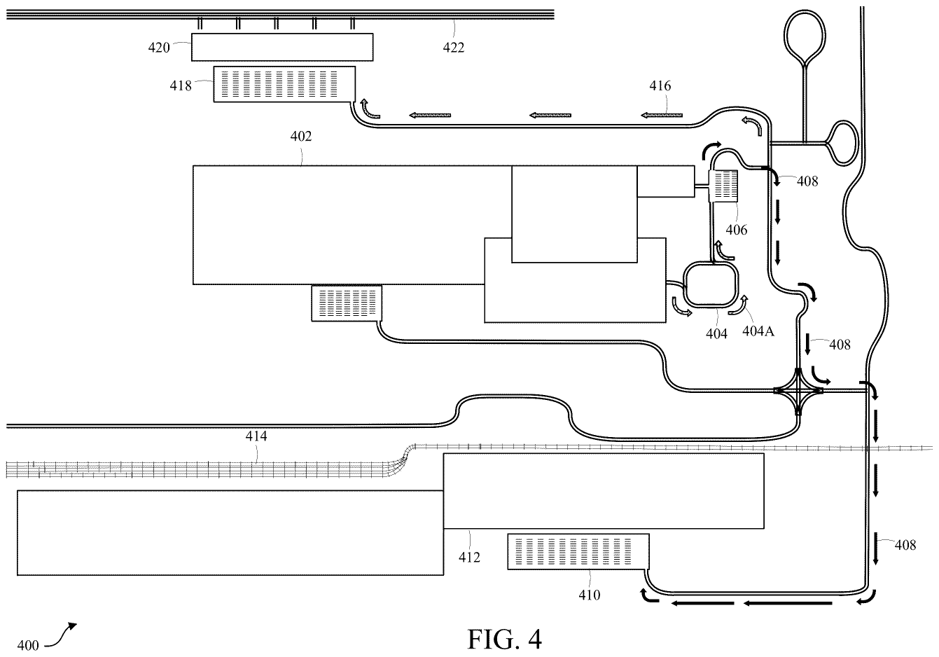

FIG. 4 illustrates an example of a controlled roadway region 400, in accordance with the present disclosure. The controlled roadway region 400 may be, be similar to, include, or be included in, an automotive manufacturing and distribution facility. The controlled roadway region 400 encompasses various interconnected areas and facilities designed to manage the flow of finished vehicles from production to distribution.

As shown, the controlled roadway region 400 may include a factory 402 at which vehicles (or one or more aspects thereof) are assembled and emerge as finished vehicles. The journey of a finished vehicle from the assembly line to its final destination involves numerous steps and potential bottlenecks. Adjacent to the factory 402 is a test course 404, where newly manufactured vehicles may undergo initial performance and quality checks. This proximity allows for quick identification and resolution of any issues that may arise immediately after production.

A handover lot 406, situated near the factory 402, serves as a transition point in the logistics chain. It may function as a staging area where vehicles are prepared for the next phase of their journey, whether that involves further testing, temporary storage, or immediate distribution. The presence of this handover lot 406 underscores the benefits of efficient space utilization and seamless transitions between different stages of the post-production process. In some implementations, a finished vehicle that emerges from the factory 402 may follow a first route (indicated by the arrows labeled 404A) as it traverses the test course 404 and then into the handover lot 406. The finished vehicle may be driven by a human driver (e.g., a manufacturing engineer) off of the assembly line, out of the factory 402, through the test course 404, and into the handover lot 406 at which time the finished vehicle is handed over to another human driver to be driven to a next location.

As shown, for example, the finished vehicle may exit the handover lot 406 and be driven along a second route (indicated by the arrows labeled 408) to a parking lot 410 associated with a railway distribution hub 412. The railway distribution hub 412, which includes a railyard 414, offers a high-volume transportation option for long-distance vehicle delivery. Some finished vehicles may instead take a third route (indicated by the arrows labeled 416) to a parking lot 418 associated with a trucking distribution hub 420, which may facilitate loading finished vehicles onto trucks for transportation via a highway 422. The trucking distribution hub 420 provides flexibility for shorter-distance transportation or for reaching areas not serviced by rail.

The traffic patterns within the controlled roadway region 400 may be characterized by a unique blend of predictable and variable elements. In some aspects, the majority of vehicles traversing this area may follow predetermined routes, creating a structured flow of traffic. These routes may typically be short, designed to efficiently move finished vehicles from the factory 402 through various stages such as the test course 404, handover lot 406, and ultimately to distribution points like the railway distribution hub 412 or trucking distribution hub 420. However, the controlled roadway region 400 may not be exclusively populated by finished vehicles on predetermined paths.

In some implementations, the roadways within the controlled region 400 may also accommodate other types of vehicles. For instance, employees' personal vehicles may be present, traversing routes to parking areas or between different facilities within the complex. Additionally, service vehicles, such as maintenance trucks or forklifts, may operate within the area, following less predictable patterns as they respond to various needs across the facility. Furthermore, the controlled roadway region 400 may not be limited to vehicular traffic. Pedestrians, including employees, visitors, or maintenance personnel, may be present in certain areas, necessitating additional considerations for safety and traffic management.

Despite the relatively short distances of the predetermined routes within the controlled roadway region 400, the cumulative impact of using human drivers for these journeys may be substantial. In some cases, the high volume of finished vehicle production (which may exceed, for example, 100,000 vehicles per year) may result in an extremely high total of driven miles and drive time when human drivers are employed to move vehicles along these routes. This accumulation of short trips may translate into significant labor costs, as well as increased potential for human error or inconsistency in vehicle handling. Moreover, the repetitive nature of these short drives may lead to driver fatigue or reduced attention, potentially compromising safety and efficiency.

In light of these challenges, a temporary automated solution, such as the one provided by the present disclosure, may offer important benefits in this scenario. By implementing a system for autonomous control of finished vehicles within the controlled roadway region 400, manufacturers may potentially reduce labor costs associated with short-distance vehicle movements. In some implementations, this approach may also enhance consistency in vehicle handling and routing, potentially improving overall efficiency and reducing the likelihood of minor damages or delays that can occur with frequent human interventions. Furthermore, an automated system may be capable of operating continuously, potentially allowing for more flexible and extended operational hours without the limitations imposed by human driver shifts or fatigue considerations.

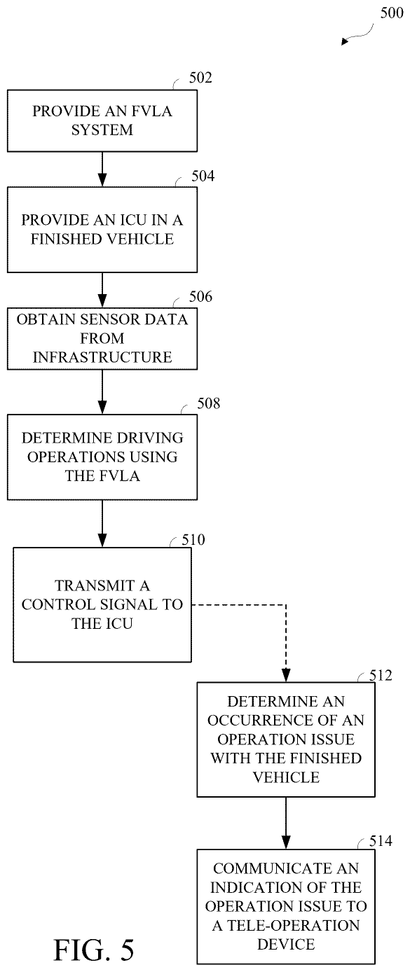

FIG. 5 is a flow diagram illustrating an example of a process 500 for controlling a finished vehicle in a controlled roadway region, in accordance with the present disclosure. Some implementations of controlling a finished vehicle in a controlled roadway region may include moving the finished vehicle from an assembly line to a distribution hub, moving the finished vehicle from the assembly line to a test course, traversing the test course, and/or moving the finished vehicle from the assembly line to an examination area, among other examples. The controlled roadway region may include any type of controlled roadway region such as, for example, the controlled roadway region 400 shown in FIG. 4.

At 502, an FVLA system located outside of a finished vehicle is provided. This FVLA system may be configured to determine driving operations for controlling the finished vehicle. In some aspects, the FVLA system may be implemented as a cloud-based system, utilizing advanced computing resources to process data and generate control instructions. The FVLA system may be designed to interface with various components of the controlled roadway region 400, such as the infrastructure components along the roadway, the railway distribution hub 412, and the trucking distribution hub 420.

At 504, a removable ICU for temporary installation in the finished vehicle is provided. The ICU may include at least one sensor, which may be used to gather data about the vehicle's environment and operational status. In some implementations, the ICU may be designed to be easily installed and removed from various vehicle models, allowing for flexibility in the types of vehicles that can be controlled within the system. The ICU may be temporarily installed in vehicles as they exit the factory 402 and/or after they reach the handover lot 406, among other examples. The FVLA system and ICU may enable autonomous control throughout the controlled roadway region 400.

At 506, the FVLA system obtains sensor data from an infrastructure. The infrastructure may include any number of different hardware and/or software components configured to gather data for use by the FVLA system. For example, the infrastructure may include sensors such as, for example, radar, LIDAR, cameras, and/or any number of other types of sensors. In some implementations, the infrastructure may include one or more of the sensors that are typically installed in autonomous vehicles such as, for example, autonomous vehicles built for Level 4 (L4) (also referred to as “high driving automation” (HAD)) autonomous driving (AD) operations.

At 508, the FVLA system generates driving instructions based on the sensor data. The driving instructions are intended for controlling the finished vehicle to traverse a transportation network of the controlled roadway region. The transportation network may include various elements depicted in FIG. 4, such as the roadway, the test course 404, and the paths leading to the distribution hubs 412 and 420. In generating these instructions, the FVLA system may take into account factors such as the current location of the vehicle, its destination, traffic conditions within the controlled roadway region, and any scheduled testing or quality control procedures.

At 510, the FVLA system transmits a control signal to the ICU, where the control signal is indicative of the driving instructions generated in step 508. This transmission may occur wirelessly, utilizing communication infrastructure within the controlled roadway region 400. The communication infrastructure may include any number of different types of wireless communication networks such as, for example, a private cellular network (e.g., using an unlicensed 5G band), an IoT network, and/or a public cellular network, among other examples. The control signal may contain detailed instructions for the vehicle's movement, including speed, direction, and specific actions to be taken at various points along its route.

In some implementations, the driving instructions, when executed by a processor of the ICU, may be configured to cause the ICU to control the finished vehicle to drive from an assembly line to at least one of a test course or a distribution hub. For example, the instructions may direct the vehicle to exit the factory 402 and proceed to the test course 404 for initial quality checks. Alternatively, the instructions may guide the vehicle directly to the railway distribution hub 412 or the trucking distribution hub 420, depending on its final destination and the chosen mode of transportation.

The FVLA system used in this method may include cloud-based L4 AD software. This advanced software may enable the system to handle complex driving scenarios within the controlled roadway region 400 without human intervention under normal circumstances. The L4 autonomy may allow the vehicles to navigate intersections and make decisions about routing and movement without constant human oversight.

To facilitate communication between the FVLA system and the finished vehicle, the ICU may include a communication component configured to communicate with the FVLA system. This communication component may utilize various wireless technologies to maintain a constant connection with the FVLA system, ensuring that the vehicle can receive updated instructions and report its status in real-time as it moves through the controlled roadway region 400.

For integration with the vehicle's systems, the ICU may comprise a connection component configured to connect with a control area network (CAN) bus of the finished vehicle. This connection allows the ICU to interface directly with the vehicle's internal systems, enabling precise control over the vehicle's movements and functions. Through the CAN bus connection, the ICU may be able to control the vehicle's steering, acceleration, braking, and other critical functions necessary for autonomous operation within the controlled roadway region 400.

In some aspects of the process 500, additional steps may be implemented to enhance the system's flexibility and safety. For instance, at 512, the FVLA system may determine an occurrence of an operation issue with a finished vehicle and, at 514, the FVLA system may communicate an indication of the operation issue to a tele-operation device associated with a remote operator. In some examples, the process 500 may include receiving additional instructions from the tele-operation device to control the finished vehicle, and controlling the finished vehicle based on these additional instructions. In other examples, the additional instructions may be provided directly from the tele-operation device to the ICU. In this way, some implementations may allow for human intervention when necessary, such as in unusual situations or when the autonomous system encounters a scenario it cannot handle independently.

To enhance the system's ability to monitor the vehicle's surroundings, the ICU may comprise a camera that is configured to be attached to a rear-view mirror or mounted to a dashboard of the finished vehicle. This camera may provide visual data to the FVLA system, allowing for more informed decision-making and potentially enabling features such as obstacle detection and avoidance as the vehicle navigates through the controlled roadway region 400.

By leveraging advanced autonomous driving technologies, removable ICUs, and a centralized logistics autonomy system, various implementations may enhance the efficiency and flexibility of post-production vehicle logistics.

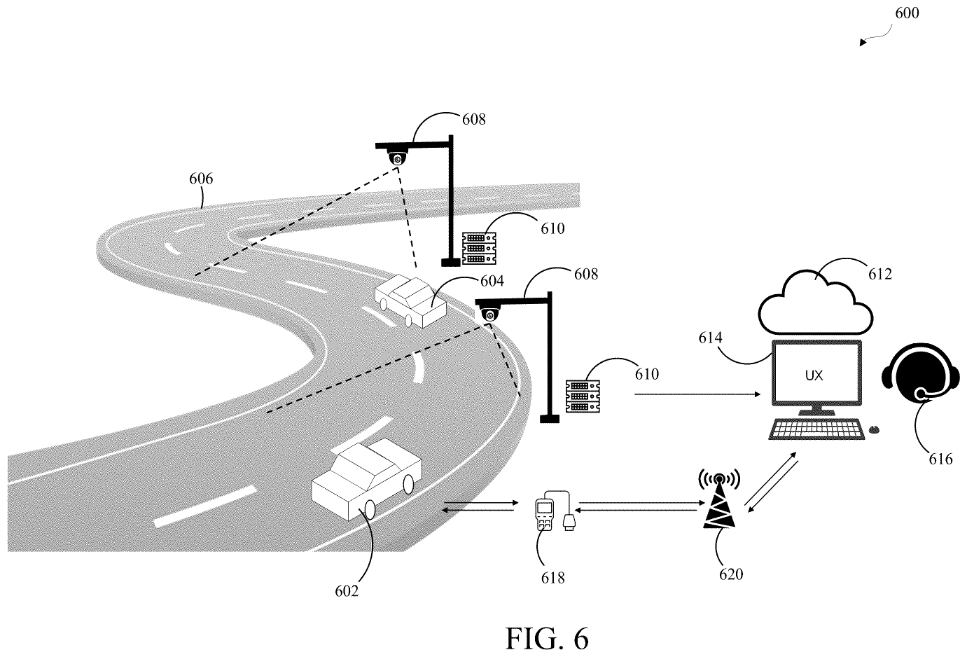

FIG. 6 is a schematic diagram showing an operating environment 600 within which aspects of the system and apparatuses described herein may be implemented. The operating environment 600 may be, be similar to, include, or be included in, a controlled roadway region where finished vehicles 602 and 604 are managed and transported autonomously such as, for example, the controlled roadway region 400 shown in FIG. 4. The operating environment 600 may be, be similar to, include, or be included in, the vehicle transportation and communication system 200 shown in FIG. 2.

The operating environment 600 includes a roadway 606. Along the roadway 606, multiple infrastructure components 608 are positioned. The infrastructure components 608 may include various sensors, cameras, and communication devices that continually monitor the environment and the vehicles 602 and 604. For example, the infrastructure components 608 may incorporate LiDAR sensors or radar systems to provide detailed environmental data.

The infrastructure components 608 may be implemented in various ways. In some implementations, the infrastructure components 608 may be affixed to and/or integrated into existing roadside equipment, such as street lights, traffic signals, or road signs. This approach may leverage pre-existing infrastructure, potentially reducing installation costs and minimizing additional visual clutter in the environment. For example, cameras or sensors may be fitted to street light poles, providing elevated vantage points for monitoring traffic flow and vehicle movements. In some implementations, the infrastructure components 608 may be standalone devices specifically designed for use with the FVLA system. These purpose-built units may be optimized for the particular requirements of the controlled roadway region, potentially offering enhanced performance or specialized capabilities. In some implementations, a combination of retrofitted existing equipment and new standalone devices may be used to create a comprehensive sensor network that covers the controlled roadway region.

The data collected by the infrastructure components 608 is fed into a perception system 610. The perception system 610 may include hardware, software, or a combination of hardware and software configured to obtain raw data from the infrastructure components 608 and process the raw data to provide sensor data, sometimes referred to as “perception data.” The perception system 610 may use advanced algorithms to detect and track vehicles, identify potential obstacles, and monitor traffic flow within the controlled roadway region.

The operating environment 600 includes an FVLA system 612. The FVLA system 612, which may be implemented as described in step 502 of FIG. 5, may be responsible for determining driving operations for controlling the finished vehicles. The FVLA system 612 receives processed data from the perception system 610 and uses this information to generate driving instructions for each vehicle in the controlled roadway region.

The operating environment 600 may include a user interface 614 communicatively coupled to the FVLA system 612. The user interface 614 may allow an operator 616 (e.g., a fleet operator) to monitor the entire system, view the status of individual vehicles, and intervene if necessary. In some implementations, the user interface 614 may serve as a tele-operation device, as described in the context of FIG. 5, enabling the operator 616 to provide additional instructions or take control of a vehicle in case of an operational issue.

Each finished vehicle 602 and 604 is equipped with an ICU 618. The ICU may be, be similar to, include, or be included in, the removable ICU described in step 504 of FIG. 5. The ICUs 618 receive control signals from the FVLA system 612 and execute the driving instructions, controlling the vehicles' movements within the operating environment 600.

Communication between the FVLA system 612 and the ICUs 618 in the vehicles is facilitated by an access point 620. This access point 620 may use wireless technology to transmit control signals and receive status updates from the vehicles, ensuring constant connectivity throughout the controlled roadway region. The wireless technology may include, for example, cellular technology.

In some implementations, the operating environment 600 could be adapted to handle various scenarios within the controlled roadway region. For instance, the FVLA system 612 may manage the movement of finished vehicles from the factory 402 to the test course 404, as described in FIG. 4. The FVLA system 612 could generate specific driving instructions for navigating the test course, while the infrastructure components 608 monitor the vehicle's performance during testing. In some implementations, the operating environment 600 may facilitate the efficient transfer of vehicles to the distribution hubs. The FVLA system 612 could coordinate the movement of multiple vehicles simultaneously, optimizing routes to the railway distribution hub 412 or the trucking distribution hub 420 based on real-time conditions and scheduling requirements.

Any one or more of the infrastructure components 608, the perception system 610, the FVLA system 612, the user interface 614, the access point 620, and/or the ICU 618, may be, be similar to, include, or be included in, the computing device 300 shown in FIG. 3.

Similarly, the vehicle 602 and/or the vehicle 604 may be, be similar to, include, or be included in, the vehicle 100 shown in FIG. 1.

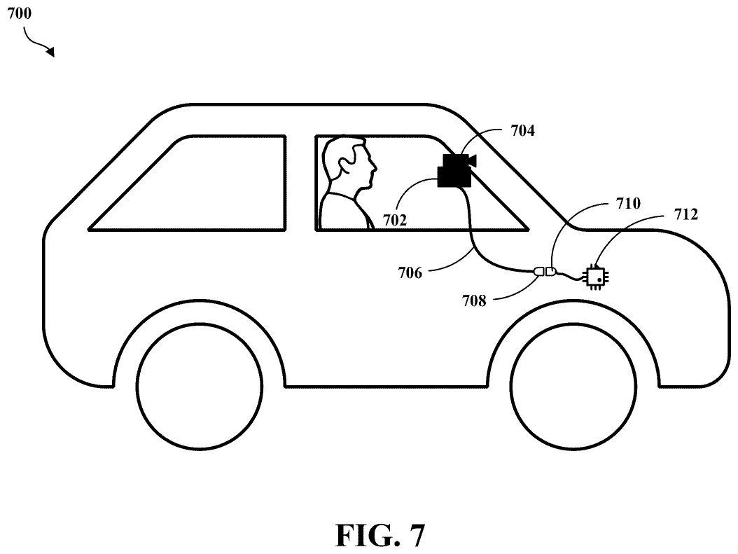

FIG. 7 is a diagram of an example of a vehicle 700 having an ICU 702 temporarily installed therein, in accordance with the present disclosure. The vehicle 700 represents a finished product that has at least partially completed the manufacturing process and is ready for autonomous navigation within a controlled roadway region. It may be any type of vehicle produced in the factory 402, as shown in FIG. 4, and is now prepared for movement to various locations such as the test course 404 or distribution hubs 412 and 420. The vehicle 700 may be, be similar to, include, or be included in, the finished vehicle 602 and/or the finished vehicle 604 shown in FIG. 6. The ICU 702 may be, be similar to, include, or be included in, the ICU 618 shown in FIG. 6.

The ICU 702 may be designed to be easily installed and removed, allowing for flexibility in equipping different vehicles with autonomous capabilities as they move through the controlled roadway region. The ICU 702 is shown mounted in a position that provides optimal access to the vehicle's systems and clear line of sight for any integrated sensors. This placement may be on the dashboard or windshield area, ensuring that the unit does not interfere with the vehicle's standard operations or safety features.

A camera 704 is connected to the ICU 702, serving as a sensor for the autonomous system and/or for tele-operations. The camera 704 is positioned to capture the view in front of the vehicle 700, providing visual data that the FVLA system 612 can use for navigation, obstacle detection, and environmental awareness. The ICU 702 is connected to the vehicle's systems (e.g., the CAN) via a connection cable 706 which serves as the primary interface between the ICU 702 and the vehicle's internal network, allowing for the exchange of data and control signals. The connection cable 706 may be designed to be robust and secure, ensuring reliable communication between the ICU 702 and the vehicle 700 even in challenging environmental conditions or during complex maneuvers.

At one end of the connection cable 706 is an ICU connector 708. This connector is specifically designed to interface with the ICU 702, providing a secure and efficient connection point. The ICU connector 708 may include multiple pins or interfaces to accommodate various types of data transmission and power supply to the ICU 702 via a CAN connector 710 coupled to the CAN of the vehicle 700. The CAN 712 includes a standard protocol used in most modern vehicles for internal communications between different electronic control units. By connecting to the CAN 712, the ICU 702 gains access to a wide range of vehicle data and control systems, allowing it to monitor the vehicle's status and issue commands for steering, acceleration, braking, and other functions necessary for autonomous operation. The ICU 702 acts as the on-board agent of the FVLA system, executing the driving instructions received from the FVLA system and providing real-time feedback about the vehicle's status and surroundings. This temporary installation of autonomous capabilities allows for efficient and flexible management of finished vehicles within the controlled roadway region, supporting the complex logistics operations described in the context of FIG. 4 and FIG. 5.

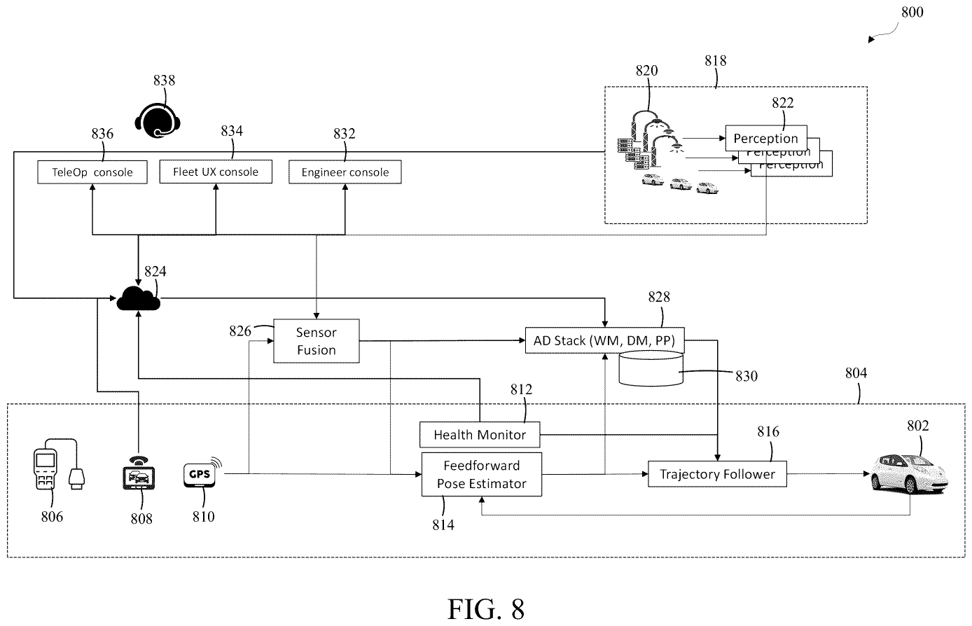

FIG. 8 is a diagram illustrating an example 800 associated with controlling a finished vehicle in a controlled roadway region, in accordance with the present disclosure. The example 800 includes a finished vehicle 802, which may be, be similar to, include, or be included in, the vehicle 700 shown in FIG. 7. The finished vehicle 802 is equipped with a vehicle network 804, which may include various onboard systems and sensors. A removable ICU 806 is temporarily installed in the finished vehicle 802, as described in the process 500 of FIG. 5. The ICU 806 may be, be similar to, include, or be included in, the ICU 702 shown in FIG. 7 and may serve as the primary interface between the vehicle 802 and the external control systems.

The ICU 806 includes several components that enable its autonomous control capabilities. A camera 808 is provided, which may be, be similar to, include, or be included in, the camera 704 in FIG. 7, and is used to capture visual data of the vehicle's surroundings. A GPS 810 is included for precise location tracking. A health monitor 812 continually assesses the status of the vehicle's systems, ensuring safe operation. A feedforward pose estimator 814 predicts the vehicle's future position and orientation, while a trajectory follower 816 executes the planned path for the vehicle 802.

In some implementations, the health monitor 812 may continually assess various vehicle systems and parameters, including but not limited to engine performance, battery status, tire pressure, brake function, steering responsiveness, communication latency, communication status, lane deviation, localization source consistency, localization updates, tele-operator over-rides, and/or clock synchronization. In some implementations, the health monitor 812 may employ a finite state machine (FSM) to coordinate vehicle control between a tele-operator, the vehicle, and an occasional human driver. In some implementations, the health monitor 812 may set a speed limit or initiate stopping of the vehicle in response to detecting an issue. This real-time monitoring may allow for early detection of potential issues that could affect the vehicle's ability to operate autonomously or compromise safety.

In cases where the health monitor 812 detects an anomaly or a deviation from expected operational parameters, it may trigger an alert within the FVLA system. The FVLA system may then evaluate the severity and nature of the issue to determine the appropriate course of action. In some instances, minor issues may be addressed through automated adjustments or by rerouting the vehicle to a maintenance area. However, for more complex or critical issues, the health monitor's alert may prompt the FVLA system to initiate a request for teleoperation.

When a teleoperation request is triggered, the system may transmit detailed diagnostic information from the health monitor to the remote operator interface. This may include specific error codes, sensor readings, and performance metrics that can help the human operator quickly assess the situation. The teleoperation interface may present this information in an easily digestible format, potentially using visual aids or augmented reality overlays to highlight the affected vehicle systems. Based on this comprehensive health data, the remote operator may make informed decisions about how to safely manage the vehicle, whether by providing specific control inputs, guiding the vehicle to a designated area for inspection, or coordinating with on-site maintenance teams for immediate intervention.

The example 800 also includes infrastructure 818, which may be, be similar to, include, or be included in, the infrastructure components 608 shown in FIG. 6. The infrastructure 818 comprises various infrastructure components 820 that generate perception data 822 about the controlled roadway region. This data may include information about road conditions, other vehicles, and potential obstacles.

The perception data 822 is transmitted to a cloud environment 824, which hosts the core processing and decision-making components of the system. Within the cloud 824, a sensor fusion component 826 integrates data from multiple sources, including the infrastructure 818 and the ICU 806. This fused data is then processed by an automated driving (AD) system 828 (shown as an “AD stack”), which may be, be similar to, include, or be included in, the FVLA system described herein. The AD system 828 includes several modules that work together to control the finished vehicle 802. These modules may include a world model (WM) that maintains a comprehensive representation of the environment, a decision making (DM) component that determines the best course of action, and a path planning (PP) module that generates optimal routes for the vehicle.

A database 830 is connected to the AD system 828, storing historical data, map information, and other relevant data that may be used by the AD system 828 to improve its decision-making capabilities. This database 830 may be continually updated with new information gathered from the vehicles and infrastructure.

The example 800 also includes several user interfaces that allow human operators to monitor and control the autonomous vehicles. An engineer console 832 may provide access to detailed system diagnostics and configuration options. A fleet UX console 834 may offer a high-level view of all vehicles operating within the controlled roadway region, allowing for efficient management of multiple vehicles simultaneously. A tele-operation console 836 may enable direct control of individual vehicles when necessary, as described in the process 500 of FIG. 5. One or more operators 838 may interact with one or more consoles 832, 834, or 836 to oversee the system's operation. The operator 838 may be similar to the operator 616 shown in FIG. 6 and can intervene in case of any issues or special circumstances that require human judgment.

The cloud environment 824 may include edge computing nodes located near the controlled roadway region, reducing latency and improving real-time responsiveness. These edge nodes could perform initial processing of perception data 822 before sending it to the central cloud system for higher-level decision making. In some aspects, the example 800 may incorporate V2V communication capabilities, allowing finished vehicles to share information directly with each other. This could enhance collision avoidance and traffic flow optimization within the controlled roadway region. The example 800 may also include interfaces with external logistics systems, enabling seamless integration with broader supply chain management processes. This could allow for dynamic routing and scheduling based on real-time demand and distribution requirements.

Some implementations of the architecture include a multi-layered approach to data flow, utilizing various communication protocols and technologies to ensure robust, real-time information exchange between different components. In some implementations, a message queuing telemetry transport (MQTT) server may be utilized within the cloud environment 824 to handle the high-volume, low-latency messaging required for real-time vehicle control. MQTT servers act as message brokers, facilitating publish-subscribe communication patterns between different components of the system. For instance, the infrastructure components 820 may publish perception data 822 to specific MQTT topics, which the sensor fusion component 826 subscribes to, ensuring efficient and timely delivery of critical environmental information.

The communication between the cloud environment 824 and the finished vehicle 802 may utilize a combination of cellular networks and dedicated short-range communications (DSRC). Cellular networks, such as 4G LTE or 5G, may provide long-range connectivity, allowing the AD system 828 to send high-level control commands and receive status updates from the ICU 806. DSRC, on the other hand, may be used for vehicle-to-infrastructure (V2I) communication, enabling low-latency exchange of safety information between the vehicle and nearby infrastructure components.

Within the finished vehicle 802, the vehicle network 804 may employ CAN bus communication, similar to the CAN 712 described in FIG. 7. This allows the ICU 806 to interface with various vehicle subsystems, receiving sensor data and sending control commands. The ICU 806 may act as a gateway, translating between the CAN protocol used internally and the external communication protocols used to interact with the cloud environment 824.

The cloud environment 824 may utilize a combination of REST (Representational State Transfer) APIs and WebSocket protocols for communication between its internal components and external interfaces. REST APIs may be used for non-real-time operations, such as updating the database 830 or retrieving configuration information. WebSocket protocols may be employed for real-time bidirectional communication, particularly for the user interfaces like the engineer console 832, fleet UX console 834, and tele-operation console 836, allowing for live updates and immediate operator interventions.

To handle the large volumes of data generated by the infrastructure 818 and multiple vehicles, the system may employ data streaming technologies. This allows for scalable, fault-tolerant distribution of data streams across the various components of the AD system 828. For example, the world model (WM) module may consume streams of fused sensor data to maintain an up-to-date representation of the environment, while simultaneously publishing updates that the decision making (DM) and path planning (PP) modules can consume.

The communication architecture also may incorporate redundancy and failover mechanisms to ensure system reliability. For instance, if the primary communication channel between the cloud environment 824 and a vehicle fails, the system may switch to a backup cellular network or even a satellite communication link. Additionally, edge computing nodes near the controlled roadway region may cache critical data and provide basic control functionality in case of temporary disconnection from the central cloud system.

The trajectory follower 816, feedforward pose estimator 814, and sensor fusion component 826 may work together to determine and maintain accurate vehicle pose and control within the controlled roadway region. The feedforward pose estimator 814, located within the ICU 806, may use data from the GPS 810 and other on-board sensors to predict the vehicle's future position and orientation. The feedforward pose estimator 814 may employ algorithms that take into account the vehicle's current state, including its velocity, acceleration, and steering angle, to estimate where the vehicle will be in the near future. This predictive capability is crucial for smooth and accurate vehicle control, as it allows the system to anticipate and prepare for upcoming maneuvers.

The sensor fusion component 826, located in the cloud environment 824, may integrate data from multiple sources to create a comprehensive understanding of the vehicle's environment and its position within it. This component may combine perception data 822 from the infrastructure components 820 with data from the vehicle's on-board sensors, including the camera 808 and GPS 810. By fusing these diverse data streams, the sensor fusion component 826 can create a more accurate and robust representation of the vehicle's pose and its surroundings than would be possible with any single sensor. This fused data may then be used by the AD system 828 to make informed decisions about vehicle control.

The trajectory follower 816, also part of the ICU 806, may use the pose estimates from the feedforward pose estimator 814 and the fused sensor data from the cloud environment 824 to execute the planned path for the vehicle. This component may continuously compare the vehicle's current and predicted positions with the desired trajectory generated by the PP module of the AD system 828. Based on this comparison, the trajectory follower 816 may generate control commands to adjust the vehicle's steering, acceleration, and braking to maintain the desired path. The trajectory follower 816 may also adapt to real-time changes in the environment or unexpected deviations from the planned path, ensuring that the vehicle remains on course and avoids obstacles.

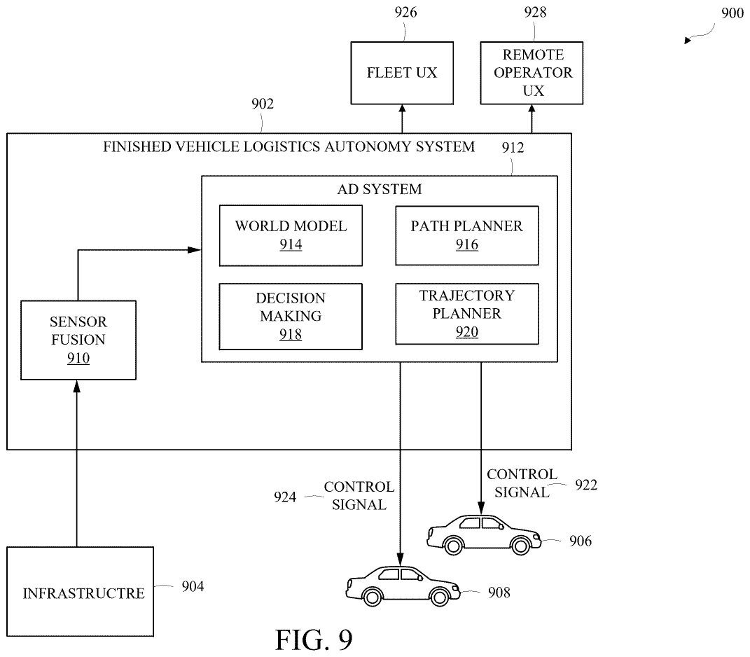

FIG. 9 is a diagram illustrating another example 900 associated with controlling a finished vehicle in a controlled roadway region, in accordance with the present disclosure. As shown in FIG. 9, the example 900 includes an FVLA system 902, which may be located outside of finished vehicles and configured to determine driving operations for controlling the finished vehicles. The FVLA system 902 interacts with infrastructure 904 and multiple vehicles, represented by vehicle 906 and vehicle 908. The infrastructure 904 may include various sensors and communication devices positioned throughout the controlled roadway region, similar to the infrastructure components 820 shown in FIG. 8. The FVLA system 902 may be, be similar to, include, or be included in, the AD system 828 shown in FIG. 8 and/or the FVLA system 612 shown in FIG. 6. The infrastructure 904 may be, be similar to, include, or be included in, the infrastructure components 820 shown in FIG. 8 and/or the infrastructure components 608 shown in FIG. 6.

In some implementations, the infrastructure components 904 may undergo periodic calibration to ensure accurate and reliable data collection. This calibration process may involve comparing sensor readings from the infrastructure components with known reference values or measurements taken by highly accurate calibration equipment. For example, cameras used for vehicle detection and tracking may be calibrated using specially designed calibration targets placed at predetermined locations within the controlled roadway region. These targets may feature specific patterns or markings that allow for precise alignment and focus adjustments of the cameras.

LiDAR sensors within the infrastructure 904 may be calibrated using a combination of static and dynamic methods. In static calibration, fixed objects with known dimensions and reflectivity properties may be placed at various distances from the LiDAR sensors. The sensors' measurements of these objects can then be compared to their actual dimensions to assess and adjust accuracy. Dynamic calibration may involve using a calibration vehicle equipped with high-precision GPS and inertial measurement units (IMUs) to drive through the controlled roadway region. The vehicle's known position and trajectory can be compared to the LiDAR sensors' measurements to fine-tune their performance.

In some implementations, infrastructure sensors may be calibrated using a three-stage calibration process. During a first stage, an initial calibration stage, rotation angle of the sensors and the position of the sensors in the environment map may be corrected. During a second stage, a transformation stage, a calibration vehicle may be used to specifically align the reference frame to the calibration vehicle being driven along an area of interest. A third stage, a piece-wise transform stage, may involve enhancing, based on a position from the calibration vehicle, specific areas of the environment where sensors typically perform poorly due to factors such as occlusion, blindspot, or poor relative orientation of the vehicle. The calibration process may be used to generate a calibration configuration which may be applied to the infrastructure sensors.

In some aspects, the calibration process may be automated and integrated into the FVLA system 902. The system may periodically run self-diagnostic routines on the infrastructure components 904, identifying any sensors that deviate from expected performance parameters. When discrepancies are detected, the system may automatically schedule maintenance or recalibration procedures, minimizing downtime and ensuring consistent data quality. Additionally, the FVLA system 902 may employ machine learning algorithms to continuously refine its understanding of sensor behavior and compensate for minor variations or drift in sensor readings over time.

Alternative embodiments may include a mobile calibration unit that can be deployed throughout the controlled roadway region. This unit may consist of a vehicle or drone equipped with high-precision sensors and calibration equipment. The mobile unit can move to different locations within the region, performing on-site calibration of infrastructure components without the need for extensive downtime or dismantling of fixed sensors. This approach may be particularly useful for large-scale controlled roadway regions or facilities with diverse environmental conditions that may affect sensor performance differently in various areas.

As shown in FIG. 9, the FVLA system 902 includes a sensor fusion component 910, which receives and processes data from the infrastructure 904 and the vehicles 906, 908. The sensor fusion component 910 may combine data from multiple sources to create a comprehensive understanding of the environment and the state of each vehicle. The sensor fusion component 910 may utilize advanced algorithms to filter, align, and integrate data from various sensors, ensuring that the system has the most accurate and up-to-date information for decision-making.

Connected to the sensor fusion component 910 is an AD system 912, which is responsible for generating driving instructions for controlling the finished vehicles to traverse the transportation network of the controlled roadway region. The AD system 912 may include several sub-components that work in concert to achieve this goal.

The world model 914 may maintain a real-time representation of the controlled roadway region, including the positions and states of all vehicles, road conditions, and any potential obstacles or hazards. This world model 914 may serves as the foundation for decision-making processes within the system 912.

In some implementations, the world model 914 receives sensor data, such as from the infrastructure 904 and/or the sensor fusion component 910, and determines (e.g., converts to, detects, etc.) objects from the sensor data. That is, the world model 914 determines hazard objects (e.g., road users) from the received sensor data. For example, the world model 914 can convert a point cloud received from a LIDAR sensor into an object, such as a hazard object. Sensor data from several sensors can be fused together to identify the objects. Examples of objects include a non-motorized vehicle (e.g., a bicycle), a pedestrian or animal, a motorized vehicle, etc.

The world model 914 can receive sensor information that allows the world model 914 to calculate and maintain additional information for at least some of the detected objects. For example, the world model 914 can maintain a state for at least some of the determined objects. The state for an object can include zero or more of a velocity, a pose, a geometry (such as width, height, and depth), a classification (e.g., bicycle, large truck, pedestrian, road sign, etc.), and a location. As such, the state of an object includes discrete state information (e.g., classification) and continuous state information (e.g., pose and velocity).

The world model 914 tracks objects, maintains lists of hypotheses for at least some of the dynamic objects (e.g., an object A might be going straight, turning right, or turning left), creates and maintains predicted trajectories for each hypothesis, and maintains likelihood estimates of each hypothesis (e.g., object A is going straight with probability 90% considering the object pose/velocity and the trajectory poses/velocities). In an example, the world model 914 uses an instance of the trajectory planner 920 to generate the predicted trajectories for each object hypothesis for at least some of the dynamic objects. For example, an instance of the trajectory planner 920 can be used to generate predicted trajectories for vehicles, bicycles, and pedestrians. In another example, an instance of a trajectory planner 920, such as the trajectory planner 920 described below, can be used to generate predicted trajectories for vehicles and bicycles, and a different method can be used to generate predicted trajectories for pedestrians. The objects maintained by the world model 914 can include hazard objects, which can include static objects, dynamic objects, or both.

Working in conjunction with the world model 914 is the path planner 916. The path planner 916 generates potential paths for each vehicle based on their current positions and intended destinations. The path planner 916 may consider factors such as road layout, traffic conditions, and vehicle capabilities when determining optimal routes. In some implementations, the path planner 916 determines a road-level plan. For example, given a starting location and a destination location, the path planner 916 determines a route from the starting location to the destination location. The path planner 916 can determine the list of roads (i.e., the road-level plan) to be followed by the vehicle to navigate from the starting location to the destination location.

The road-level plan determined by path planner 916 and the objects (and corresponding state information) maintained by the world model 914 can be used by the decision making component 918 to determine discrete-level decisions along the road-level plan. Examples of decisions included in the discrete-level decisions may include: stop at the next intersection, move forward slowly, accelerate to a certain speed limit, merge into the next lane, etc. For example, the decision making component 918 may evaluate the paths generated by the path planner 916 and select the most appropriate course of action for each vehicle. The decision making component 918 may consider various factors such as safety, efficiency, and adherence to traffic rules when making decisions. In some implementations, the decision making component 918 may utilize machine learning algorithms to improve its decision-making capabilities over time.

Once a decision has been made, the trajectory planner 920 generates detailed trajectories for each vehicle. These trajectories specify the exact path, speed, and maneuvers that a vehicle should follow to execute the chosen path safely and efficiently. For example, the trajectory planner 920 can receive the discrete-level decisions, the objects (and corresponding state information) maintained by the world model 914, and the predicted trajectories and likelihoods of the external objects from the world model 914. The trajectory planner 920 can use at least some of the received information to determine a detailed-planned trajectory, also referred to herein as a proactive trajectory, for the vehicle.

For example, the trajectory planner 920 determines a next-few-seconds trajectory. As such, and in an example where the next few seconds are the next 6 seconds (i.e., a look-ahead time of 6 seconds), the trajectory planner 920 determines a trajectory and locations for the vehicle in the next 6 seconds. For example, the trajectory planner 920 may determine (e.g., predict, calculate, etc.) the expected locations of the vehicle at several time intervals (e.g., every one-quarter of a second, or some other time intervals).

In some implementations, the AD system 912 and/or the ICU installed in a vehicle may include a reactive trajectory control component. For example, the reactive trajectory control component may be a software module of the AD system or may be, be similar to, include, or be included in, the trajectory follower 816 shown in FIG. 8. The reactive trajectory control component can handle situations that the vehicle may encounter but may not be handled by the trajectory planner 920. Such situations include situations where the proactive trajectory of the trajectory planner 920 was based on misclassification of objects and/or unanticipated situations that rarely occur. For example, the reactive trajectory control can modify the proactive trajectory in response to determining that a static object to the left of the vehicle is misclassified. The object may have been classified as a large truck; however, a new classification determines that it is a static road barrier wall. In another example, the reactive trajectory control can modify the proactive trajectory in response to a sudden tire blowout of the vehicle. Other examples of unanticipated situations include another vehicle swerving suddenly (e.g., due to late decision to get to highway off-ramp or tire blowout) into the lane of the vehicle and a pedestrian or other object emerging suddenly from behind an occlusion.

In some implementations, a predictive algorithm of the trajectory planner 920 may be configured to produce plans at 10 hz; on the other hand, the reactive trajectory control may be configured to produce plans at 100 hz.

The FVLA system 902 communicates with the vehicles 906, 908 through control signals 922, 924 respectively. These control signals may be transmitted to removable ICUs temporarily installed in the finished vehicles, similar to the ICU 806 described in FIG. 8. The control signals 922, 924 are indicative of the driving instructions generated by the AD system 912 and may cause the ICUs to control the finished vehicles to traverse the transportation network of the controlled roadway region.

In some implementations, the example 900 may include a fleet UX 926, which provides a user interface for managing and monitoring multiple vehicles simultaneously. This interface may allow operators to view the status and location of all vehicles in the system, track their progress, and identify any potential issues or bottlenecks in the logistics process.

Additionally, the example 900 includes a remote operator UX 928, which may serve as a tele-operation device. This interface allows human operators to remotely monitor and control individual vehicles when necessary. In some cases, the system may determine an occurrence of an operation issue with a finished vehicle and communicate an indication of the operation issue to the remote operator UX 928. The operator can then use this interface to send additional instructions to control the finished vehicle, ensuring safe and efficient resolution of any issues that may arise.

In some implementations, the FVLA system 902 may incorporate cloud-based L4 AD software, enabling advanced decision-making capabilities and reducing the need for human intervention in most scenarios. The system may also utilize edge computing nodes near the controlled roadway region to process data from the infrastructure 904 and vehicles 906, 908 more quickly, reducing latency and improving real-time responsiveness. In some implementations, the example 900 may be further enhanced by incorporating V2V communication capabilities, allowing finished vehicles to share information directly with each other. This could improve collision avoidance and enable more efficient traffic flow within the controlled roadway region. For example, if vehicle 906 detects an obstacle, it could immediately communicate this information to vehicle 908 and the FVLA system 902, allowing for rapid adjustments to trajectories and decision-making.

The FVLA system 902 may also be designed to handle various scenarios within the controlled roadway region, such as moving finished vehicles from an assembly line to a test course or distribution hub. The FVLA system 902 could generate specific driving instructions for navigating these different areas, taking into account the unique requirements and constraints of each location.

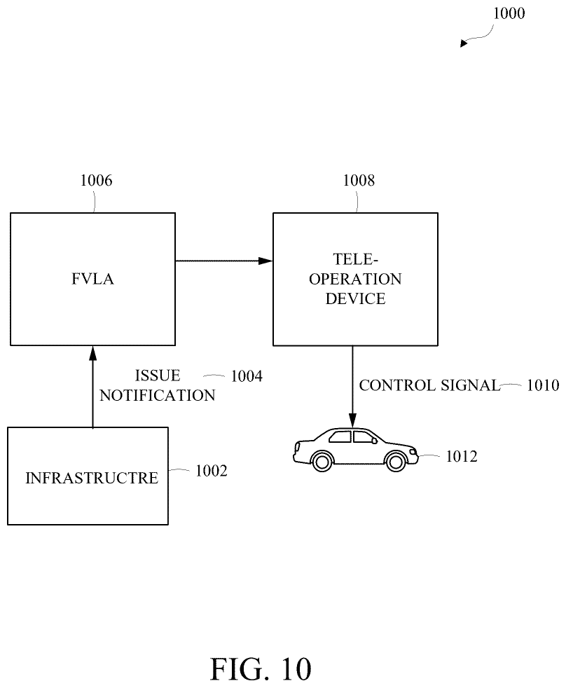

FIG. 10 is a schematic diagram illustrating an example 1000 associated with using a tele-operation device to control a finished vehicle in a controlled roadway region, in accordance with the present disclosure. The example 1000 demonstrates how an FVLA system may handle operational issues and allow for human intervention when necessary.

The example 1000 includes infrastructure 1002, which may comprise various sensors, cameras, and communication devices positioned throughout the controlled roadway region. These infrastructure components continuously monitor the environment and the vehicles within it. In some aspects, the infrastructure 1002 may include advanced sensor systems such as LiDAR, radar, and high-resolution cameras to provide detailed information about road conditions, weather, and other environmental factors that may affect vehicle movement. The infrastructure 1002 may be, be similar to, include, or be included in, the infrastructure 904 shown in FIG. 9.

When the infrastructure 1002 detects an operational issue or anomaly, it sends an issue notification 1004 to the FVLA system 1006. The issue notification 1004 may include information about the nature of the problem, its location, and any relevant sensor data. The FVLA system 1006, which may be located outside of the finished vehicles, is configured to determine driving operations for controlling the finished vehicles under normal circumstances. However, when it receives an issue notification 1004, the FVLA system 1006 may determine that human intervention is necessary.

In such cases, the FVLA system 1006 communicates with a tele-operation device 1008. The tele-operation device 1008 may serve as a remote operator user interface, allowing a human operator to monitor and control individual vehicles when necessary. The tele-operation device 1008 may include displays showing real-time video feeds from the vehicle and its surroundings, as well as controls for remotely operating the vehicle.

Upon receiving information about the operational issue from the FVLA system 1006, a human operator using the tele-operation device 1008 can assess the situation and determine the appropriate course of action. The operator may then generate additional instructions to control the finished vehicle, which are sent as a control signal 1010 to the vehicle 1012. This control signal 1010 may override or supplement the normal autonomous driving instructions generated by the FVLA system 1006.

The vehicle 1012 receives the control signal 1010 through its ICU, which may be a removable unit temporarily installed in the finished vehicle. The ICU interprets the control signal 1010 and executes the instructions to control the vehicle's movements and actions. This may involve adjusting the vehicle's speed, steering, or other operational parameters to navigate around an obstacle, move to a safe location, or perform any other necessary maneuver to address the identified issue.

In some implementations, one or more aspects of the FVLA system 1006, the tele-operation device 1008, the ICU, and/or the infrastructure 1002 may incorporate machine learning algorithms to learn from these tele-operation interventions. Over time, this could enable the system to handle an increasing number of scenarios autonomously, reducing the need for human intervention. Additionally, the tele-operation device 1008 may be equipped with augmented reality features, allowing the operator to visualize potential paths and outcomes before sending control signals to the vehicle.

The FVLA system 1006 may also include a feedback loop where the actions taken during tele-operation are recorded and analyzed. This data could be used to improve decision-making capabilities of the FVLA system 1006 and to update the world model and path planning algorithms. Furthermore, the FVLA system 1006 could incorporate predictive maintenance features, where data from multiple tele-operation events is analyzed to identify patterns that might indicate impending issues with vehicles or infrastructure components.

In some implementations, the system 1000 may allow for collaborative tele-operation, where multiple operators can work together to resolve complex issues. For example, one operator might control the vehicle's movement while another manages communication with other vehicles or infrastructure components in the vicinity. This collaborative approach could be particularly useful in managing large-scale events or coordinating the movement of multiple vehicles in a congested area of the controlled roadway region.

The foregoing disclosure provides illustration and description but is not intended to be exhaustive or to limit the aspects to the precise forms disclosed. Modifications and variations may be made in light of the above disclosure or may be acquired from practice of the aspects. As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, the terminology “instructions” may include directions or expressions for performing any technique, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, techniques, or combinations thereof, as described herein. Instructions, or a portion thereof, may be implemented as a special purpose processor, or circuitry, that may include specialized hardware for carrying out any of the techniques, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

As used herein, the terminology “example”, “embodiment”, “implementation”, “aspect”, “feature”, or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify”, or any variations thereof, includes selecting, ascertaining, computing, looking up, receiving, determining, establishing, obtaining, or otherwise identifying or determining in any manner whatsoever using one or more of the devices shown and described herein. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, the terminology “or” is intended to mean an inclusive “or” rather than an exclusive “or” and may be used interchangeably with “and/or,” unless explicitly stated otherwise (for example, if used in combination with “either” or “only one of”), or clearly is used otherwise from context. In addition, the articles “a” and “an” as used in this application and the appended claims should generally be construed to mean “one or more” unless specified otherwise or clear from context to be directed to a singular form. Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more. ” As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Accordingly, unless explicitly stated otherwise, the phrase “based on” is intended to mean “based at least in part on.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. Further, for simplicity of explanation, although the figures and descriptions herein may include sequences or series of steps or stages, elements of the techniques disclosed herein may occur in various orders or concurrently. Additionally, elements of the techniques disclosed herein may occur with other elements not explicitly presented and described herein. Furthermore, not all elements of the techniques described herein may be required to implement a technique in accordance with this disclosure. Although aspects, features, and elements are described herein in particular combinations, each aspect, feature, or element may be used independently or in various combinations with or without other aspects, features, and elements.

The above-described aspects, examples, and implementations have been described in order to allow easy understanding of the disclosure are not limiting. On the contrary, the disclosure covers various modifications and equivalent arrangements included within the scope of the appended claims, which scope is to be accorded the broadest interpretation so as to encompass all such modifications and equivalent structure as is permitted under the law.

What is claimed is:

1. A method of controlling a finished vehicle in a controlled roadway region, comprising:
providing a finished vehicle logistics autonomy (FVLA) system located outside of the finished vehicle, the FVLA system configured to determine driving operations for controlling the finished vehicle;
providing a removable In-Vehicle Controller Unit (ICU) for temporary installation in the finished vehicle, the ICU including at least one sensor;
generating, using the FVLA system, driving instructions for controlling the finished vehicle to traverse a transportation network of the controlled roadway region; and
transmitting a control signal to the ICU, the control signal indicative of the driving instructions.

2. The method of claim 1, wherein the driving instructions, when executed by a processor of the ICU, are configured to cause the ICU to control the finished vehicle to drive from an assembly line to at least one of a test course or a distribution hub.

3. The method of claim 1, wherein the FVLA system comprises cloud-based level four (L4) autonomous driving software.

4. The method of claim 1, wherein the ICU comprises a communication component configured to communicate with the FVLA system.

5. The method of claim 1, wherein the ICU comprises a connection component configured to connect with a control area network (CAN) bus of the finished vehicle.

6. The method of claim 1, further comprising:
receiving additional instructions from a tele-operation device to control the finished vehicle; and
controlling the finished vehicle based on the additional instructions.

7. The method of claim 1, further comprising:
determining an occurrence of an operation issue with the finished vehicle;
communicating an indication of the operation issue to a tele-operation device;
receiving additional instructions from the tele-operation device to control the finished vehicle; and
controlling the finished vehicle based on the additional instructions.

8. The method of claim 1, wherein the ICU comprises a camera that is configured to be attached to a rear-view mirror or mounted to a dashboard of the finished vehicle.

9. A system for controlling a finished vehicle in a controlled roadway region, comprising:
a finished vehicle logistics autonomy (FVLA) system located outside of the finished vehicle, the FVLA system configured to:
generate driving instructions for controlling the finished vehicle to traverse a transportation network of the controlled roadway region; and
transmit a control signal indicative of the driving instructions to an In-Vehicle Controller Unit (ICU); and
the ICU including at least one sensor, the ICU configured to:
receive the control signal from the FVLA system;
determine the driving instructions based on the control signal; and
control the finished vehicle to traverse the controlled roadway.

10. The system of claim 9, wherein the FVLA system comprises cloud-based level four (L4) autonomous driving software.

11. The system of claim 9, wherein the ICU comprises a communication component configured to communicate with the FVLA system.

12. The system of claim 9, wherein the ICU comprises a connection component configured to connect with a control area network (CAN) bus of the finished vehicle.

13. The system of claim 9, wherein the ICU comprises a camera that is configured to be attached to a rear-view mirror or mounted to a dashboard of the finished vehicle.

14. The system of claim 9, wherein the ICU is configured to:
receive additional instructions from a tele-operation device; and
control the finished vehicle based on the additional instructions.

15. The system of claim 9, wherein the FVLA system is configured to:
detect an occurrence of an operation issue with the finished vehicle; and
communicate an indication of the operation issue to a tele-operation device.

16. An apparatus for facilitating control of a finished vehicle in a controlled roadway region, comprising:
a processor of an In-Vehicle Controller Unit (ICU) configured to cause the ICU to:
receive a control signal indicative of driving instructions from a finished vehicle logistics autonomy (FVLA) system located outside of the finished vehicle; and
control the finished vehicle to traverse a transportation network of the controlled roadway region.

17. The apparatus of claim 16, wherein the FVLA system comprises cloud-based level four (L4) autonomous driving software.

18. The apparatus of claim 16, wherein the processor is further configured to cause the ICU to:
receive additional instructions from a tele-operation device; and
control the finished vehicle based on the additional instructions.

19. The apparatus of claim 16, wherein the processor is further configured to:
obtain sensor data indicative of an operation issue with the finished vehicle; and
communicate an indication of the operation issue to the FVLA system.

20. The apparatus of claim 16, wherein the ICU comprises a camera that is configured to be attached to a rear-view mirror or mounted to a dashboard of the finished vehicle.
